(19) United States
(12) Patent Application Publication
(10) Pub. No.: US 2014/0014603 A1
(43) Pub. Date: Jan. 16, 2014

(54) SPICE RACK WITH ADJUSTABLE CARRIAGES

(71) Applicant: Alan S. Thompson, Kelley, IA (US)

(72) Inventor: Alan S. Thompson, Kelley, IA (US)

(21) Appl. No.: 13/547,440

(22) Filed: Jul. 12, 2012

(51) Int. Cl. A47J 47/16

(52) U.S. Cl. 211/78; 211/71.01; 211/85.18

(57) ABSTRACT

A carousel rack assembly is provided with a plurality of carriages coupled together end-to-end for rotation. Each carriage includes a plurality of spice compartments. Adjacent carriages can be coupled in a first position wherein the spice container compartments are aligned or in a second position wherein the spice container compartments are offset. When the compartments are aligned into adjacent carriages, a tall spice container or two short spice containers can be held in the aligned compartments. When the compartments of adjacent carriages are offset, a small spice container can be held in each offset compartment.

### BACKGROUND OF THE INVENTION

Spice bottles or jars generally come in two relatively standard sizes, tall and short. Spice racks having various designs for holding these containers have been known for many years. However, prior art racks generally hold only the tall containers or the short containers, but not both.

Conventional carousel style spice racks have a carriage which is rotatably mounted on a spindle for easy display of the spice containers. Applicant's U.S. Pat. No. 7,275,647 shows one style of carousel spice rack having a plurality of elongated tracks for holding different size spice containers. The tracks are rotatably mounted on a spindle for selection of a desired spice container. Applicant's co-pending application Ser. No. 12/251,052 shows another carousel-type spice rack wherein the spice compartments are offset with respect to one another. The offset arrangement of the rows of compartments limits the lower compartments to hold only short spice containers, and not tall spice containers.

Therefore, a primary objective of the present invention is the provision of an improved spice rack wherein the compartments can be selectively arranged for holding either tall or short spice containers.

Another objective of the present invention is the provision of a spice rack having adjustable carriages for accommodating short and tall spice containers.

A further objective of the present invention is the provision of a spice rack wherein the rows of compartments can be selectively aligned or offset relative to one another, as desired by a user.

Still another objective of the present invention is the provision of a carousel spice rack assembly having adjustably stacked carriages, each having a plurality of spice container compartments.

Yet another objective of the present invention is the provision of a carousel style spice rack assembly with vertically arranged carriages which can be rotated with respect to one another so as to align or offset the spice container compartments of the carriages.

A further objective of the present invention is the provision of a spice rack assembly with stacked carriages with a detent system for fixing the orientation of the stacked carriages relative to one another.

Another objective of the present invention is the provision of an improved spice rack carousel having vertically stacked carriages with male and female couplings between the adjacent carriages.

Another objective of the present invention is the provision of an improved spice rack assembly having a plurality of rotatable spice container compartments.

A further objective of the present invention is the provision of an improved spice rack assembly which securely holds tall and short cylindrical spice containers, and allows quick and easy removal of an individual spice container.

Yet another objective of the present invention is the provision of a spice rack assembly which is economical to manufacture and durable in use.

These and other objectives will become apparent from the following description of the invention.

### SUMMARY OF THE INVENTION

The carousel spice rack assembly of the present invention includes a plurality of carriages each having a plurality of radially spaced spice container compartments. The carriages have opposite ends, with adjacent carriages having a male/female coupling therebetween. The adjacent carriages can be selectively coupled so that the spice container compartments of the first carriage are aligned or offset with respect to the spice container compartments of the second carriage. The carriages can be rotatably mounted upon a base so as to be in a vertical orientation, or can be supported at the opposite ends in a horizontal orientation.

### BRIEF DESCRIPTION OF THE DRAWINGS

FIG. 1 is a perspective view of the spice rack of the present invention with the spice compartments arranged in a first configuration.

FIG. 2 is a side elevation view of the spice rack shown in FIG. 1.

FIG. 3 is an exploded perspective view of the spice rack shown in FIG. 1.

FIG. 4 is an exploded side elevation view of the spice rack shown in FIG. 1.

FIG. 5 is a top perspective view of one of the carriages of the spice rack of FIG. 1.

FIG. 6 is a bottom perspective view of one of the carriages of the spice rack shown in FIG. 1.

FIG. 7 is a bottom perspective view of the cap of the spice rack shown in FIG. 1.

FIG. 8 is a perspective view of an optional tool used to release the lock button between two adjacent stacked carriages.

FIG. 9 shows another configuration of the carriages of the spice rack according to the present invention, with spice containers stored in the carriage compartments.

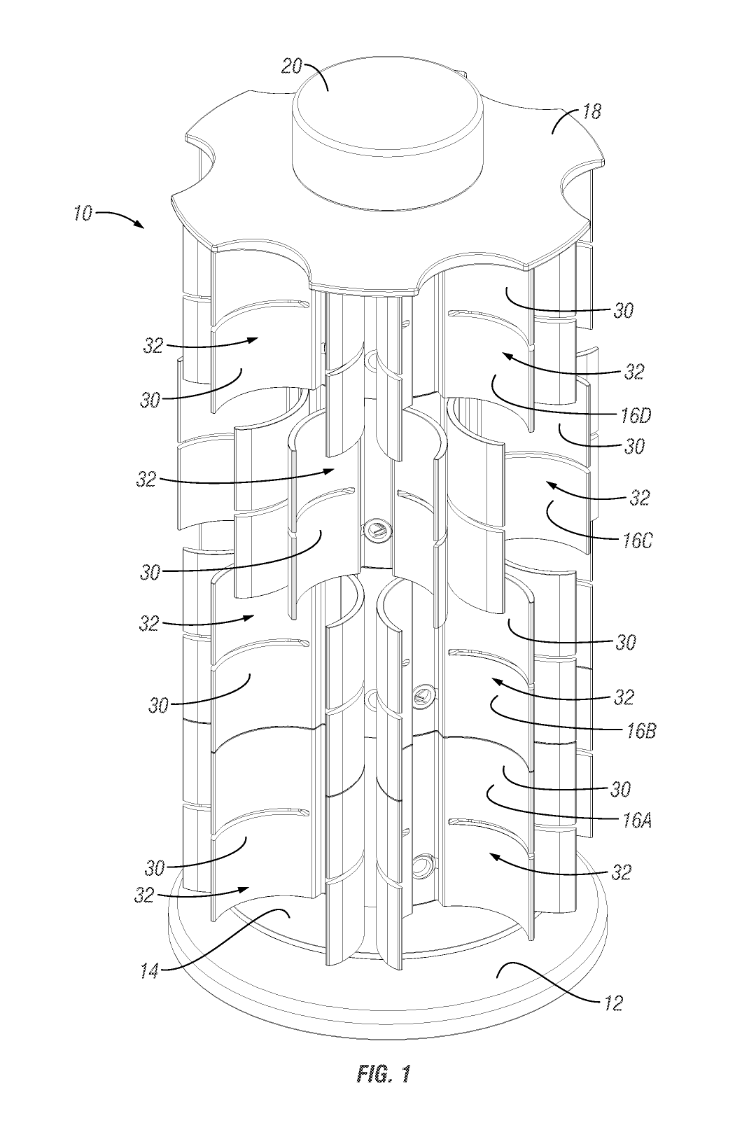

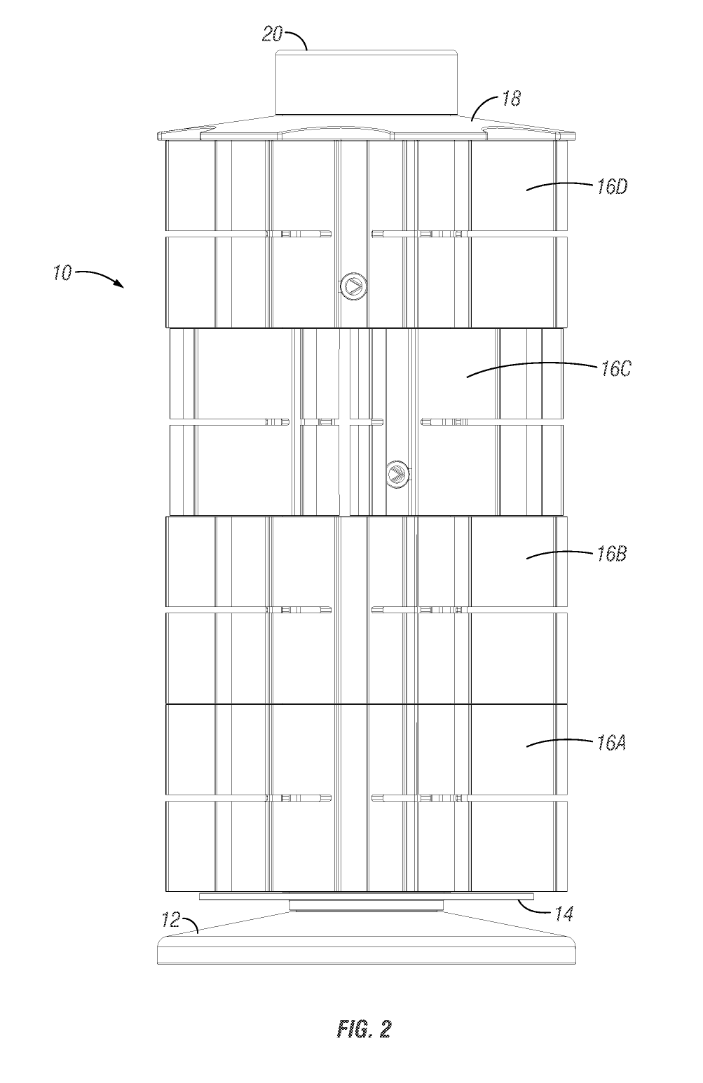

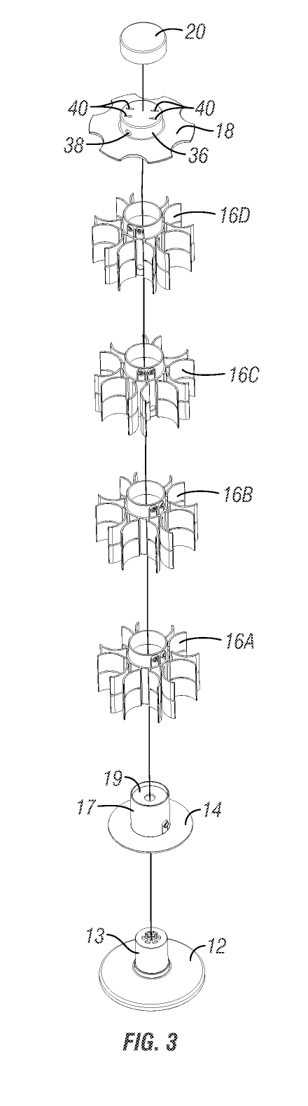

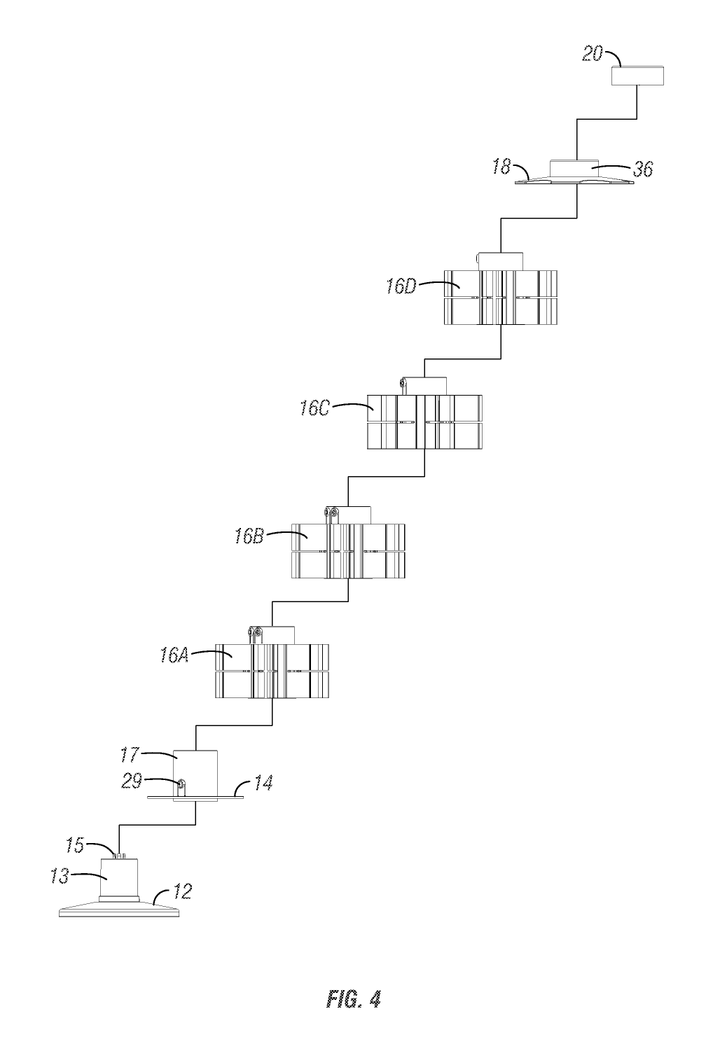

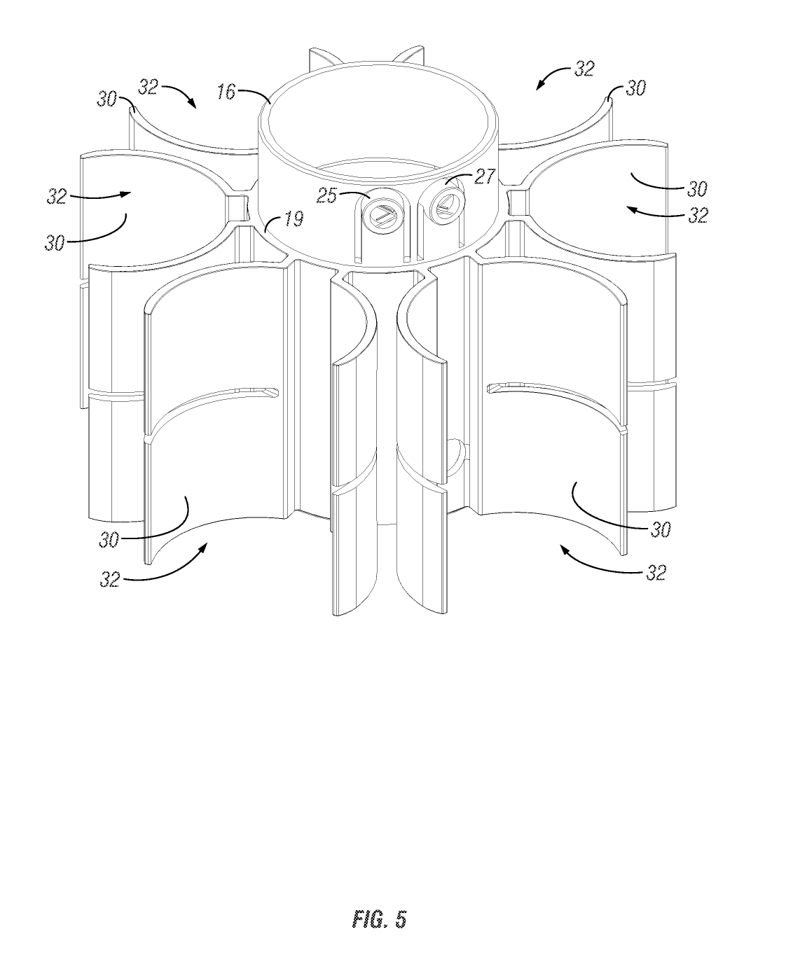

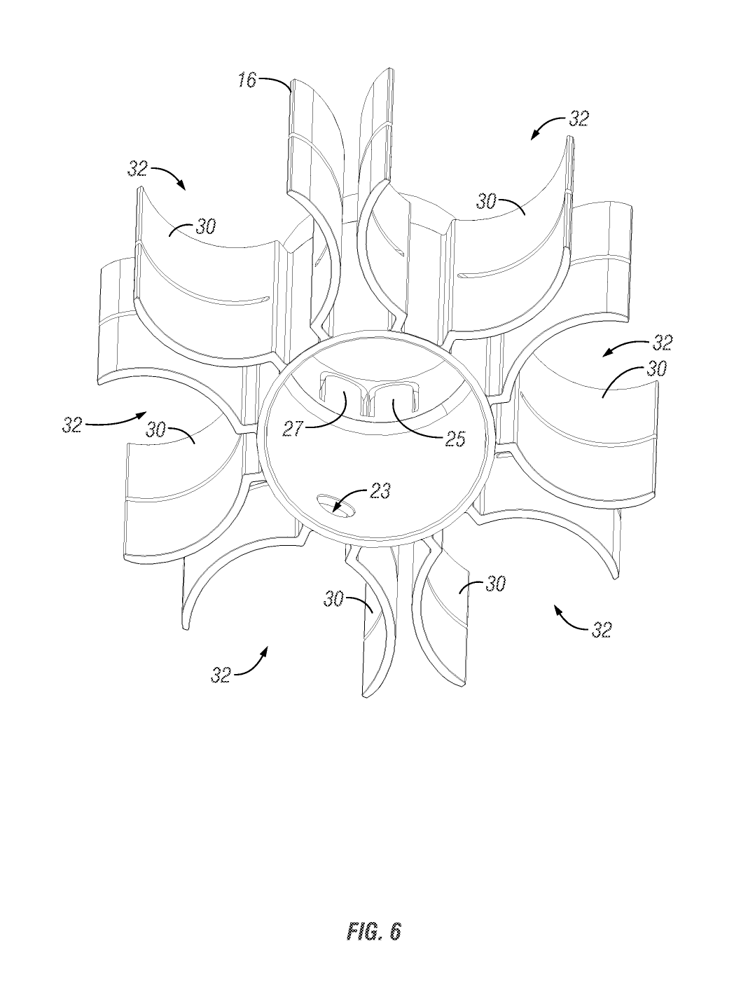

### DETAILED DESCRIPTION OF THE PREFERRED EMBODIMENT

The spice rack of the present invention is generally designated by the reference numeral 10 in the drawings. The rack 10 includes four basic components, the base 12, the turntable 14, the plurality of carriages 16, and a top cover 18. A cap 20 can also be attached to the cover 18. While the drawings show four carriages 16A, 16B, 16C, and 16D, it is understood that more or less carriages may be used on the rack 10. The carriages 16A-D are identical in construction.

The base 12 includes an upstanding post or column 13 with a radially extending groove and a top flexible button 15 formed with a plurality of resilient prongs. The turntable 14 has a hollow upstanding column 17 with an internal diameter slightly greater than the exterior diameter of the column 13 of the base 12. The turntable 14 includes a top wall with a hole 19 therein through which the button 15 of the top of the base 12 extends to retain the turntable 14 on the base 12. Thus, the turntable 14 is rotatably supported on the base 12. The base 12 is stationary.

Each carriage 16A-D has a hollow tubular body 19 and a reduced diameter, hollow tubular neck 21. The inside diameter of the body 19 is slightly larger than the outside diameter of the neck 21 such that the neck of a first carriage can be received in the body of an adjacent carriage. Thus, the body 19 and neck 21 of adjacent carriages forms a female/male coupling between the stacked or connected carriages.

The body 19 includes a hole 23 at the lower end and a pair of resilient buttons or detents 25, 27 at the upper neck 21, such that adjacent carriages can be snap fit together with one of the detents 25, 27 of the neck 21 being received in the hole 23 in the body 19. The dual detents 25, 27 allow the carriages to be aligned, as seen with carriages 16A and 16B, or offset, as seen with carriages 16C and 16D, depending on which detent is in the hole. As an alternative to dual neck detents 25, 27 and body hole 23, the body 19 may include a horizontal slot (not shown) and the neck have a single resilient button or detent receivable in the slot so that adjacent carriages can be rotated relative to one another for alignment or an offset orientation.

The bottom carousel 16A fits onto the column 17 of the turntable 14. The turntable 14 extends only into the body 19 of the lowest carousel segment 16A. Since the segments 16A-16D are interconnected, no spindle is necessary to extend through the segments 16B-D. A button 29 on the turntable 14 is received into the hole 23 or slot of the carousel 16A, and can be depressed into a groove or recess (not shown) of the base 10 to detach the segment 16A.

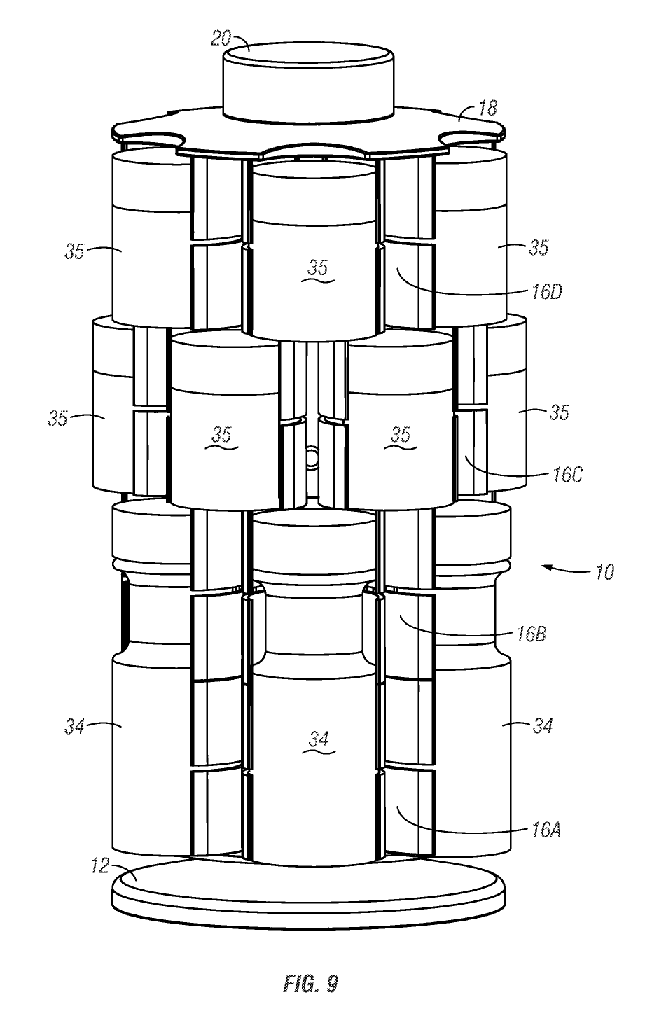

Each carriage 16A-D includes a plurality of C-shaped resilient clips 30. Each clip 30 defines a compartment 32 for receiving and holding a spice container. In the preferred embodiment, each carriage has six compartment 32 spaced radially about the body 19. More or fewer compartments may be provided, depending on the diameter of the body 19. Preferably, the clips 30 are integrally formed on the body 19 of the carriage. The rotational adjustability of the carriages provided by the slot and button of adjacent carriages allows the compartments 32 of upper and lower carriages to be aligned or offset. When aligned, vertically adjacent compartments 32 can receive and hold a tall spice container 34 or two short containers 35, as shown in FIG. 9. When offset, the compartments 32 are adapted to only hold short spice containers.

The carriages are designed to be stacked one upon the other with the body 19 of an upper carriage being matingly received on the neck 21 of the adjacent lower carriage, and with one of the buttons 25, 27 of the lower carriage received in the hole 23 or slot of the adjacent upper carriage. The hole/slot and button assembly between adjacent carriages allows the carriages to rotate 30° (based on six compartments on each carriage) relative to one another for alignment or offset stacking of the compartments. The hole or slot receives the pin or button to maintain adjacent carriages in a selected aligned or offset orientation of the compartments 32. Any small tool, such as a pencil, or even a finger, may be used to press the buttons to unlock stacked carriages.

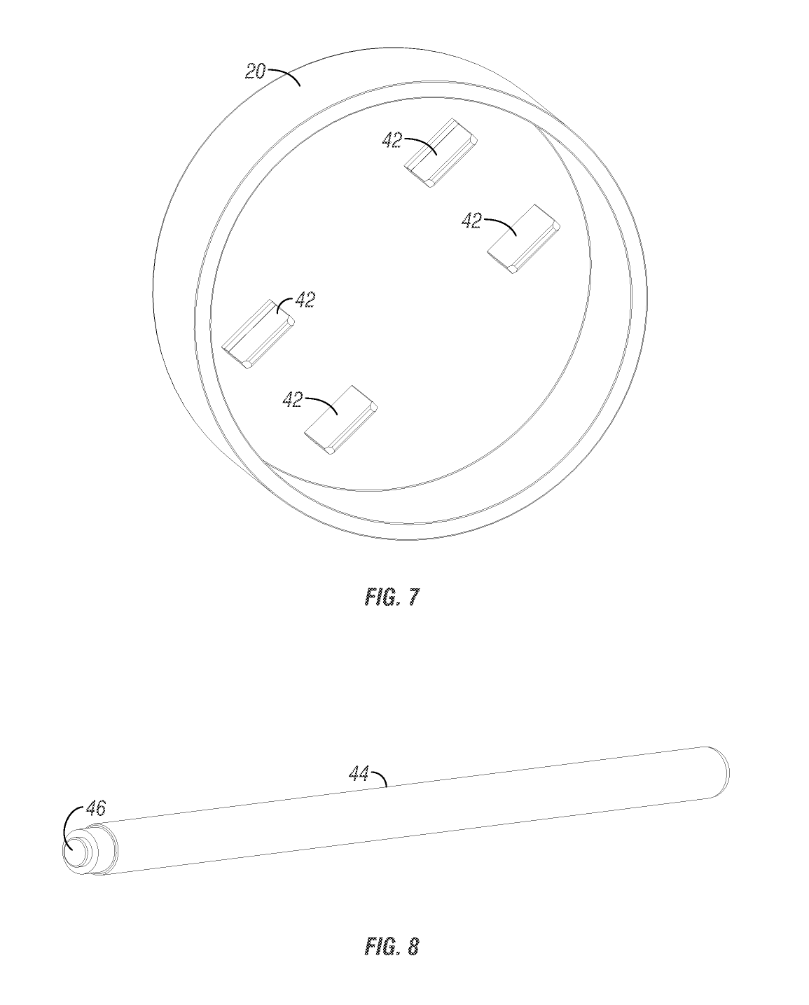

The cover 18 includes a tubular column 36 extending downwardly so as to fit over the neck 21 of the top carriage 16D. A hole 38 in the cover column 36 is adapted to receive one of the pins or buttons 25, 27 of the top carriage to maintain the cover on the top carriage 16D. The top of the cover 18 has one or more holes 40 adapted to receive corresponding legs 42 extending downwardly from the bottom of the cap 20, as shown in FIG. 7, so as to retain the cap 20 on the cover 18.

A person can use their finger or other small or pointed object to press a locked detent 25, 27 on adjacent carriages to unlock the adjacent carriages. An optional tool 44 (shown in FIG. 8) may be used to depress or release the carriage detents 25, 27, so that stacked carriages can be disassembled. The tool 44 has a working end with a diameter slightly smaller than the diameter of the carriage body hole 23 or slot. When it is desired to disassemble or reconfigure the spice rack 10, the tool end 46 can be inserted into the hole 23 or slot to depress the neck detent 25, 27, and thereby release an upper adjacent carriage from the lower adjacent carriage. The base 12 has a pair of slots (not shown) in the bottom of the base to friction fit or press fit the tool 44 for storage. Thus, the tool 44 is kept with the spice rack 10 and is readily available when desired.

The spice rack 10 can be assembled with various configurations for the carriages. For example, in the configuration shown in FIG. 9, the clip compartments 32 of carriages 16A and 16B are aligned for holding tall containers 34, while the clip compartments of carriages 16C and 16D are offset for holding short containers 35. In another configuration (not shown), the clip compartments 32 of the lower two carriages 16A and 16B can be aligned, and the clip compartments 32 of the upper two carriages 16C and 16D can be aligned. Thus, in this configuration, the rack 10 can hold 24 short spice containers 35, 12 tall spice containers 34, or a combination of tall and short spice containers.

In an alternative configuration, the clip compartments 32 of the carriages 16A, 16B, and 16C can be offset, while the compartments 32 of carriages 16C and 16D are aligned. In this configuration, the clip compartments of carriages 16A and 16B are adapted to hold short spice containers 35, while the compartments of carriages 16C and 16D can hold either tall or short spice containers 35.

As another alternative, the clip compartments 32 of adjacent carriages can be offset, such that this rack configuration will hold 24 short containers.

In a further configuration, the clip compartments of carriages 16B and 16C can be aligned, while the clip compartments of carriages 16A and 16D can be offset with respect to carriages 16B and 16C. Thus, the middle carriages 16B and 16C can hold tall containers 34 while the upper and lower carriages 16A and 16D can hold short containers 35.

The rack assembly 10 shown in the drawings is portable, such that the assembly 10 can be placed on a kitchen countertop or stored in a cabinet or pantry. While the drawings show the rack assembly 10 to be vertically oriented, it is to be understood that the rack could also be horizontally oriented. For example, the opposite ends of the coupled carriages 16A-D can be supported by a bracket beneath a kitchen cabinet, similar to a paper tower rack.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A spice rack assembly comprising:
a base;
a first carriage rotatably mounted on the base, and having a first row of radially spaced spice container compartments;
a second carriage mounted on top of the first carriage for rotation therewith, and having a second row of radially spaced spice container compartments;
a detent system on the first and second carriages to allow the first and second rows to be moved between a first position with the compartments in first and second row being aligned and a second position with the compartments in the first and second rows being offset.

2. The spice rack assembly of claim 1 wherein the detent system includes a button on one of the carriages and a recess on the other of the carriages to receive the button.

3. The spice rack assembly of claim 1 wherein the button is resiliently mounted on the one carriage.

4. The spice rack assembly of claim 1 wherein the recess is a horizontal groove.

5. The spice rack assembly of claim 1 wherein the carriages rotate approximately 30° relative to one another between the first and second positions.

6. The spice rack assembly of claim 1 wherein the second carriage is free from an internal spindle.

7. The spice rack assembly of claim 1 wherein the detent system is located between container compartments.

8. The spice rack assembly of claim 1 wherein the first carriage has a cylindrical body with a reduced diameter neck, and the second carriage has a cylindrical body to fit matingly over the neck.

9. The spice rack assembly of claim 1 wherein the first and second carriages are stacked with a male and female coupling therebetween.

10. The spice rack assembly of claim 1 wherein one of the carriages has a female end and the other of the carriages has a male end for receiving in the female end such that the first and second carriages are stacked one on top of the other.

11. A spice rack assembly, comprising:
a plurality of carriages each having upper and lower ends and a plurality of radially spaced spice container compartments;
the upper and lower ends of adjacent carriages be coupled together; and
adjacent carriages being selectively coupled in a first position wherein the compartments of the adjacent carriages are aligned and in a second position wherein the compartments of the adjacent carriages are offset.

12. The spice rack assembly of claim 11 wherein the carriages each have a cylindrical body, and the compartments extend around the body.

13. The spice rack assembly of claim 11 wherein the ends of each carriage have different diameters.

14. The spice rack assembly of claim 11 further comprising a detent connection between adjacent carriages to fix the adjacent carriages in one of the first and second positions.

15. The spice rack assembly of claim 11 wherein the carriages are mounted on a turntable.

16. The spice rack assembly of claim 11 wherein the carriages are rotatably mounted on a base.

17. The spice rack assembly of claim 16 wherein the carriages rotate together.

18. A carousel spice rack assembly, comprising:
a pair of carriages coupled together end-to-end;
each carriage having a plurality of spice container compartments; and
the carriages being selectively coupled in a first orientation with the compartments aligned and a second orientation with the compartments offset.

19. The spice rack assembly of claim 18 further comprising a resilient button to lock the carriages in one of the selected first and second orientations.

20. The spice rack assembly of claim 18 further comprising a turntable upon which the stacked carriages are mounted so as to be rotatable.
